(19) United States
(12) Patent Application Publication
(10) Pub. No.: US 2022/0153108 A1
(43) Pub. Date: May 19, 2022

(54) MULTILAYER STRUCTURE, IN-WHEEL MOTOR, AND ELECTRIC WHEEL

(71) Applicant: SONY GROUP CORPORATION, TOKYO (JP)

(72) Inventor: TAKASHI TAKAMATSU, TOKYO (JP)

(21) Appl. No.: 17/437,728

(22) PCT Filed: Mar. 3, 2020
(86) PCT No.: PCT/JP2020/008782

§ 371 Date: Sep. 9, 2021

(30) Foreign Application Priority Data
Mar. 26, 2019 (JP) 2019-058488

(51) Int. Cl. B60K 1/00; B60K 7/00; H02K 9/22; H02K 1/12; H02K 7/00; B32B 15/088; B60B 5/02

(52) U.S. Cl. CPC B60K 1/00; B60K 7/0007; H02K 9/22; H02K 1/12; B60K 2001/006; B32B 15/088; B60B 5/02; B32B 2250/03; B60K 2007/0092; H02K 7/003

(57) ABSTRACT

A multilayer structure (1) includes a metallic material (2), a thermoplastic first resin material (3) bonded to the metallic material (2), and a thermoplastic second resin material (4) that is bonded to the first resin material (3) and contains carbon, the metallic material (2), the thermoplastic first resin material (3), and the thermoplastic second resin material (4) being stacked on one another.

### TECHNICAL FIELD

The present disclosure relates to a multilayer structure, an in-wheel motor, and an electric wheel.

### BACKGROUND ART

Conventionally, it has been a general practice to use an adhesive for bonding a metallic material and a sheet-shaped resin material. PTL 1 discloses an example of a multilayer structure in which a tape-shaped rubber is attached to a bonded part of a cover rubber to thereby restrain stress concentration.

### CITATION LIST

### Patent Literature

[PTL 1]

JP 2000-45252A

### SUMMARY

### Technical Problem

However, in the above-mentioned conventional technology, the adhesive is deteriorated due to aging and temperature and is lowered in bond strength, so that there is a problem that durability and reliability of the material are lowered. Since the degree of deterioration of the adhesive varies depending on the environment, it is difficult to predict the lowering in durability and reliability.

In view of the foregoing, the present disclosure proposes a multilayer structure that has high thermal conductivity and is light in weight and high in strength, an in-wheel motor, and an electric wheel.

### Solution to Problem

To solve the above-mentioned problem, a multilayer structure of one mode according to the present disclosure includes a metallic material, a thermoplastic first resin material bonded to the metallic material, and a thermoplastic second resin material that is bonded to the first resin material and contains carbon.

### BRIEF DESCRIPTION OF DRAWINGS

FIG. 1 is a schematic sectional view depicting a multilayer structure according to an embodiment of the present disclosure.

FIG. 2 is a diagram for explaining an example of a method of manufacturing the multilayer structure.

FIG. 3 is a flow chart depicting an example of the method of manufacturing the multilayer structure.

FIG. 4 is a diagram for explaining another example of the method of manufacturing the multilayer structure.

FIG. 5 is a flow chart depicting the other example of the method of manufacturing the multilayer structure.

FIG. 6 is a schematic diagram depicting an example of a holding form of an electric wheel according to a first application mode.

FIG. 7 is a sectional view of the electric wheel according to the first application mode.

FIG. 8 is an exploded perspective view of the electric wheel according to the first application mode.

FIG. 9 is an exploded perspective view of the electric wheel according to the first application mode.

FIG. 10 is an exploded perspective view of the electric wheel according to the first application mode.

FIG. 11 is an exploded perspective view of the electric wheel according to the first application mode.

FIG. 12A is an exploded perspective view of the electric wheel according to the first application mode.

FIG. 12B is an exploded perspective view of the electric wheel according to the first application mode.

FIG. 13 is a perspective view of a wheel section according to the first application mode.

FIG. 14 is a schematic diagram depicting a television set according to a second application mode of the present disclosure.

FIG. 15A is a schematic diagram depicting a back cover according to the second application mode.

FIG. 15B is a schematic diagram depicting the back cover according to the second application mode.

FIG. 16 is a schematic diagram depicting a notebook personal computer according to a third application mode of the present disclosure.

FIG. 17A is a schematic diagram depicting a bottom cover according to the third application mode.

FIG. 17B is a schematic diagram depicting the bottom cover according to the third application mode.

### DESCRIPTION OF EMBODIMENT

Embodiments of the present disclosure will be described in detail below based on the drawings. Note that, in each of the following embodiments, the same parts are denoted by the same reference signs and overlapping descriptions thereof are omitted.

### (Embodiment)

### [Configuration of Multilayer Structure]

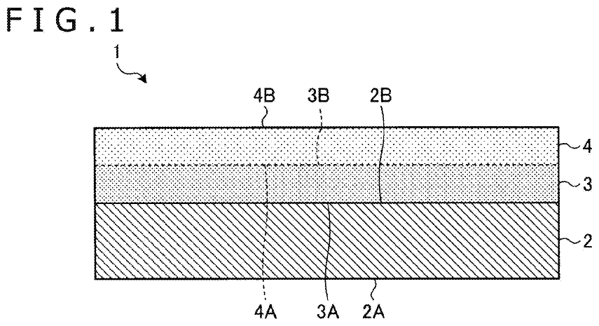

First, a configuration of a multilayer structure 1 according to an embodiment of the present disclosure will be described. FIG. 1 is a schematic sectional view depicting the multilayer structure according to the embodiment of the present disclosure. In the present disclosure, the multilayer structure 1 is used for a part needing a high heat environment and heat radiation and is applied to a part required to have high thermal conductivity. The multilayer structure 1 is applied to a part required to be light in weight and high in strength. The multilayer structure 1 is applied, for example, a rim 22 and a side cover 26 of an electric wheel 10, as depicted in a first application mode described later. The multilayer structure 1 is applied, for example, a back cover 204 of a television set 200, as depicted in a second application mode described later. The multilayer structure 1 is applied, for example, to a bottom cover 304 of a notebook personal computer 300, as depicted in a third application mode described later.

The multilayer structure 1 is a stacked body including a metallic material 2, a first resin material 3, and a second resin material 4. The metallic material 2 and the second resin material 4 are bonded to each other through the first resin material 3 by forming the first resin material 3 therebetween. The metallic material 2 is formed, for example, of a metallic material having high thermal conductivity, such as an aluminum alloy, magnesium, or iron. The metallic material 2 constitute a basic structure of a part to which the multilayer structure 1 is applied.

The first resin material 3 is a thermoplastic resin. The first resin material 3 is formed, for example, of a resin material such as a polyamide resin or a polyphenylene sulfide resin. The first resin material 3 is stacked on the metallic material 2. The first resin material 3 causes the metallic material 2 and the second resin material 4 to bond to each other. The first resin material 3 is integrally bonded to the metallic material 2. The first resin material 3 is bonded to the metallic material 2, for example, by insert molding. An end face 3A on one side of the first resin material 3 is in a shape coinciding with an end face 2B of the metallic material 2. The first resin material 3 is bonded to the second resin material 4, for example, by heat welding or hot pressing. An end face 3B on the other side of the first resin material 3 is melted with an end face 4A on one side of the second resin material 4. The first resin material 3 may be bonded to the metallic material 2 and the second resin material 4 by simultaneous insert molding. The first resin material 3 is an intermediate material for bonding the metallic material 2 and the second resin material 4, and, therefore, the first resin material 3 is preferably formed in a thin thickness of equal to or less than 1 mm.

The second resin material 4 is a thermoplastic resin containing carbon. The second resin material 4 is formed, for example, of a resin material such as a polyamide resin or a polyphenylene sulfide resin. The second resin material 4 is, for example, a sheet material of carbon fiber reinforced plastics (CFRP). The carbon fiber reinforced plastic is a fiber reinforced plastic using carbon fibers as a reinforcing material. The second resin material 4 contributes to enhancement of strength of the multilayer structure 1. The component of the second resin material 4 may be the same as the component of the first resin material 3. The second resin material 4 is stacked on the first resin material 3. The second resin material 4 is bonded to the first resin material 3, for example, by heat welding or hot pressing. The second resin material 4 may be bonded to the first resin material 3 by simultaneous insert molding with the metallic material 2.

Since the multilayer structure 1 according to the present disclosure thus forms the layer of the first resin material 3 between the metallic material 2 and the second resin material 4 to bond the latter two, it is unnecessary to use an adhesive which is liable to deteriorate by aging and environments such as temperature. Therefore, the multilayer structure 1 is high in reliability of bonding and can maintain high strength. Since the multilayer structure 1 has the metallic material 2 constituting a basic structure, the multilayer structure 1 can be applied to a part needing high thermal conductivity. In the multilayer structure 1, the first resin material 3 and the second resin material 4 contribute to reduction in weight and enhancement of strength. Therefore, the multilayer structure 1 has high thermal conductivity and can be applied to a part needing lightness in weight and high strength. The multilayer structure 1 can adjust strength and thermal conductivity by characteristics of the first resin material 3 and the second resin material 4, and, therefore, characteristics required of the part for use can be taken into consideration. For example, by forming the metallic material 2 contributing to high thermal conductivity in a thin form and by enlarging the thickness of the second resin material 4 contributing to reduction in weight and enhancement of strength, the multilayer structure 1 can be applied to a part small in thickness and needing strength.

### [First Manufacturing Method]

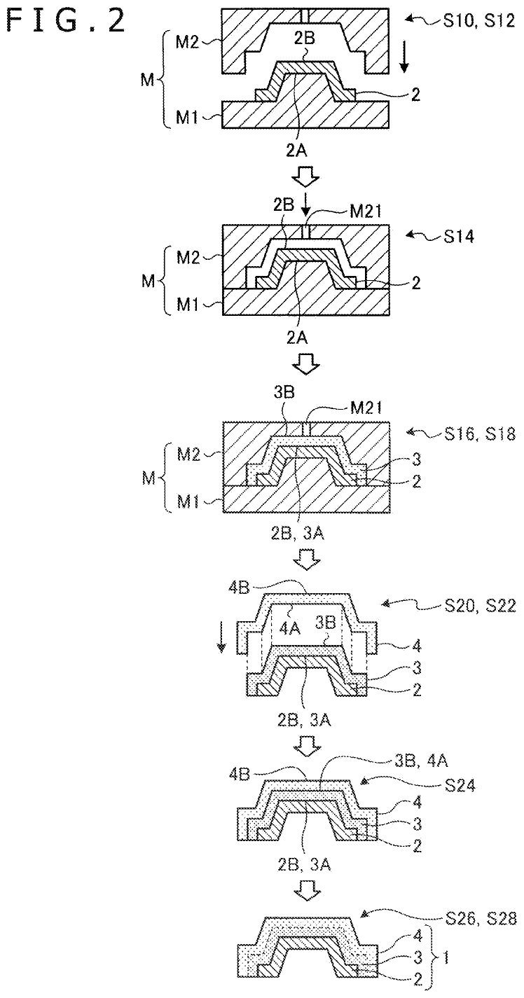

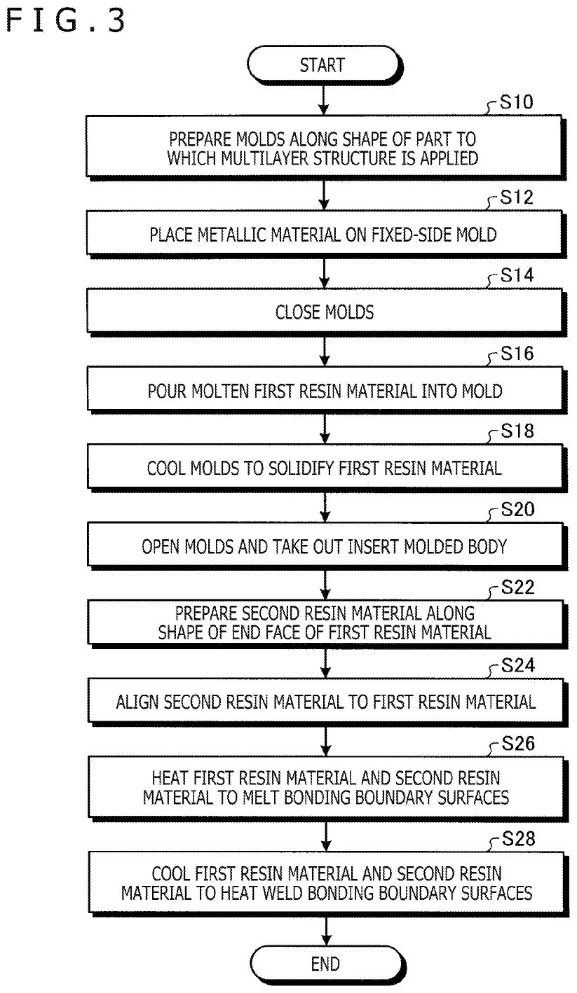

Next, an example of a method of manufacturing the multilayer structure 1 will be described. FIG. 2 is a diagram for explaining an example of a method of manufacturing the multilayer structure. FIG. 3 is a flow chart depicting an example of the method of manufacturing the multilayer structure. Note that, while a work of an operator will be described below, the work may be conducted automatically by use of a processing apparatus and a conveying apparatus and the like.

In step S10, the operator, first, prepares molds M along the shape of a part to which the multilayer structure 1 is applied. The molds M include a fixed-side mold M1 and a movable-side mold M2. On the fixed-side M1, the metallic material 2 is placed. The placing surface of the fixed-side mold M1 is formed such as to be along the shape of an end face 2A on one side of the metallic material 2. A surface of the movable-side mold M2, the surface facing the fixed-side mold M1, is formed along the shape of the end face 3B on the side opposite to the end face 3A of the first resin material 3, the end face 3A being bonded to the metallic material 2. In the first manufacturing method, the movable-side mold M2 includes an opening M21. The opening M21 is a passage through which a molten resin for forming the first resin material 3 is poured into the molds M. In step S12, the operator places the metallic material 2 on the fixed-side mold M1 in a state in which the molds M are opened.

In step S14, the operator closes the molds M. Specifically, the operator positions the movable-side mold M2 relative to the fixed-side mold M1 and puts them into close contact with each other. In this instance, it is preferable to tentatively fix the movable-side mold M2 to the fixed-side mold M1. In a state in which the movable-side mold M2 is positioned relative to the fixed-side mold M1, a gap in the same shape as that of the first resin material 3 is formed between the end face 2B of the metallic material 2 and the movable-side mold M2.

In step S16, the operator pours the molten first resin material 3 into the molds M through the opening M21, to fill the gap between an end face 2B of the metallic material 2 and the movable-side mold M2 with the molten first resin material 3. In step S18, the operator cools the molds M, to solidify the first resin material 3.

In step S20, the operator opens the molds M and takes out an insert molded body of the metallic material 2 and the first resin material 3 from the molds M. In step S22, the operator prepares the second resin material 4 having the end face 4A along the shape of the end face 3B of the first resin material 3.

In step S24, the operator aligns the second resin material 4 to the first resin material 3. In this instance, the end face 4A of the second resin material 4 and the end face 3B of the first resin material 3 are in face-face alignment.

In step S26, the operator heats the first resin material 3 and the second resin material 4. As a result, bonding boundary surfaces of the end face 3B of the first resin material 3 and the end face 4A of the second resin material 4 are melted. In step S28, the operator again cools the first resin material 3 and the second resin material 4. As a result, the bonding boundary surfaces of the end face 3B of the first resin material 3 and the end face 4A of the second resin material 4 are heat welded. By the above-mentioned method, the multilayer structure 1 is manufactured.

### [Second Manufacturing Method]

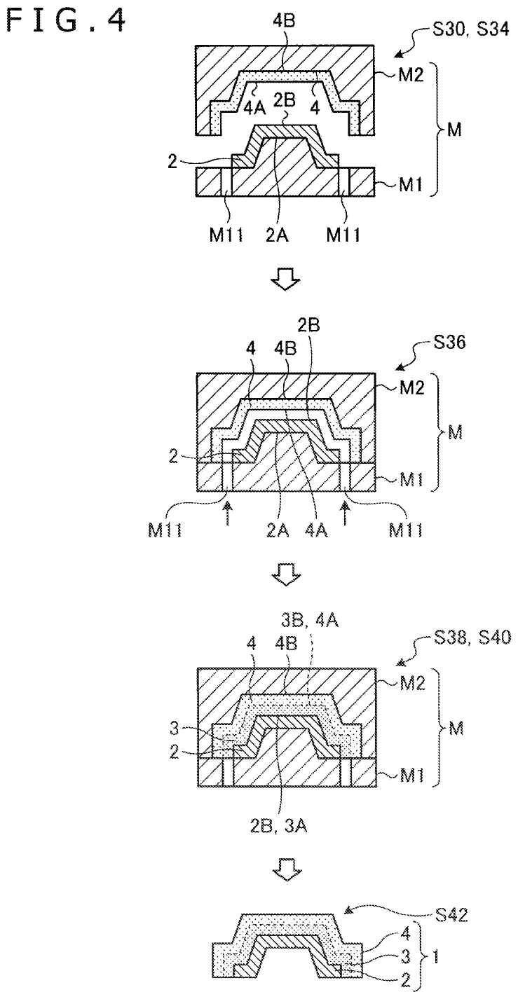

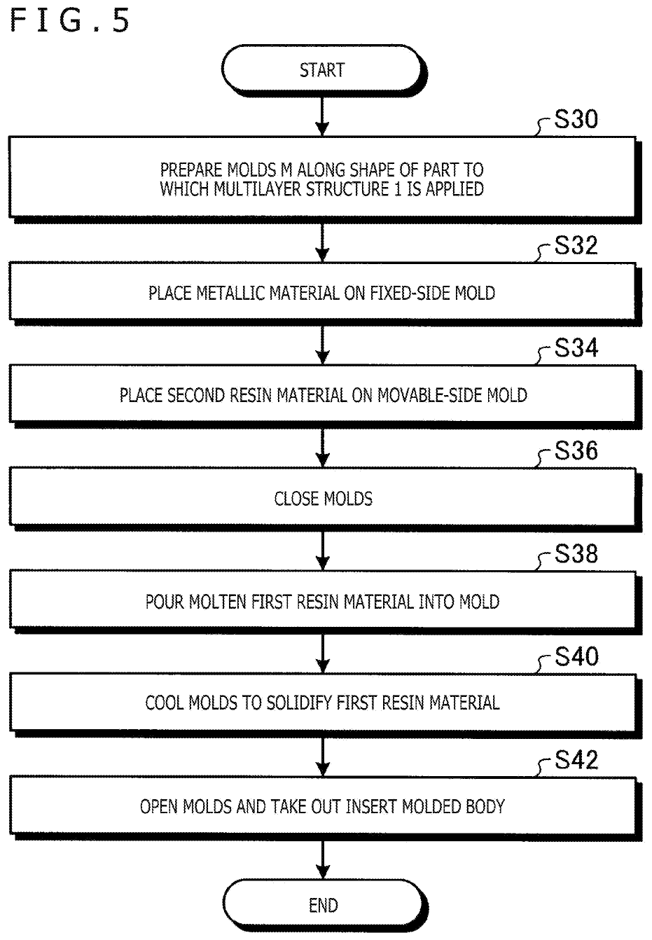

Next, another example of the method of manufacturing the multilayer structure 1 will be described. FIG. 4 is a diagram for explaining the other example of the method of manufacturing the multilayer structure. FIG. 5 is a flow chart depicting the other example of the method of manufacturing the multilayer structure. Note that, while a work of the operator will be described below, the work may be conducted automatically by use of the processing apparatus and the conveying apparatus and the like.

In step S30, the operator, first, prepares the molds M along the shape of a part to which the multilayer structure 1 is applied. The molds M include the fixed-side mold M1 and the movable-side mold M2. On the fixed-side mold M1, the metallic material 2 is placed. The placing surface of the fixed-side mold M1 is formed such as to be along the shape of the end face 2A on one side of the metallic material 2. In the second manufacturing method, the fixed-side mold M1 includes an opening M11. The opening M11 is a passage through which a molten resin for forming the first resin material 3 is poured into the molds M. On the movable-side mold M2, the second resin material 4 is placed. The placing surface of the movable-side mold M2 is formed such as to be along the shape of an end face 4B on the side opposite to the end face 4A of the second resin material 4, the end face 4A being bonded to the first resin material 3. In step S32, the operator places the metallic material 2 on the fixed-side mold M1, in a state in which the molds M are opened. In step S34, the operator places the second resin material 4 on the movable-side mold M2.

In step S36, the operator closes the molds M. Specifically, the operator positions the movable-side mold M2 relative to the fixed-side mold M1 and puts them into close contact with each other. In this instance, it is preferable to tentatively fix the movable-side mold M2 to the fixed-side mold M1. In a state in which the movable-side mold M2 is positioned relative to the fixed-side mold M1, a gap in the same shape as that of the first resin material 3 is formed between the end face 2B of the metallic material 2 and the end face 4A of the second resin material 4.

In step S38, the operator pours the molten first resin material 3 into the molds M through the opening M11, to fill the gap between the end face 2B of the metallic material 2 and the end face 4A of the second resin material 4 with the molten first resin material 3. In step S40, the operator cools the molds M, to solidify the first resin material 3.

In step S42, the operator opens the molds M, and takes out a multilayer structure 1 which is an insert molded body of the metallic material 2, the first resin material 3, and the second resin material 4 from the molds M. By the above-mentioned method, the multilayer structure 1 is manufactured.

### (First Application Mode)

[Configuration of Electric Wheel according to First Application Mode]

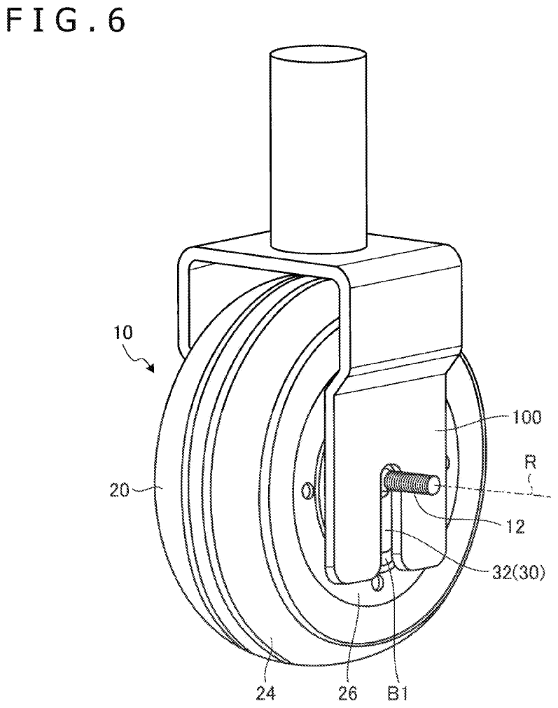

Next, a configuration of an electric wheel 10 to which the multilayer structure 1 according to the present disclosure is applied will be described. FIG. 6 is a schematic diagram depicting an example of a holding mode of an electric wheel according to a first application mode. In the present disclosure, the electric wheel 10 is mounted on a vehicle having a structure opened on both sides, such as a two-wheeled vehicle. As the two-wheeled vehicle, for example, a small-type light vehicle such as an electric kick board is assumed. The electric wheel 10, in the embodiment, is a wheel having a diameter of eight inches (204 mm). The electric wheel 10 includes a wheel section 20 and a driving device 30. The driving device 30 is an in-wheel motor provided inside the wheel section 20. On both sides of the driving device 30, fixed shafts 12 are fixed. The fixed shafts 12 are coaxial with a rotational axis R of the wheel section 20. The wheel section 20 is rotated relative to the fixed shafts 12. The electric wheel 10 is held by a support member 100 through a support section 14A and a support section 14B of the fixed shafts 12. In the embodiment, the support section 14A and the support section 14B are provided at end portions on the inside of the respective fixed shafts 12. In the embodiment, the support member 100 is a front fork of a two-wheeled vehicle.

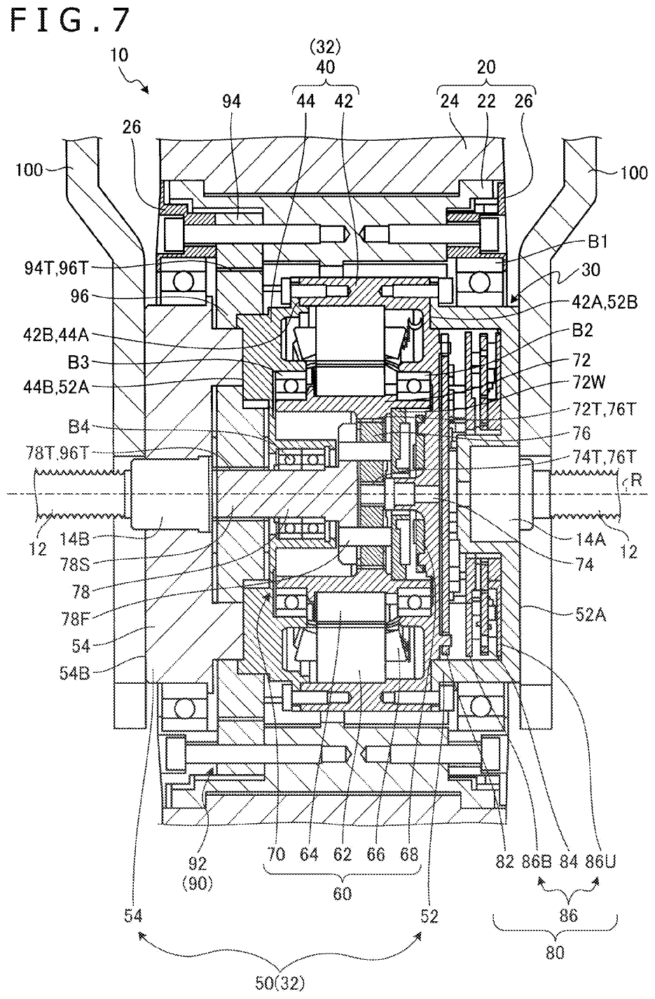

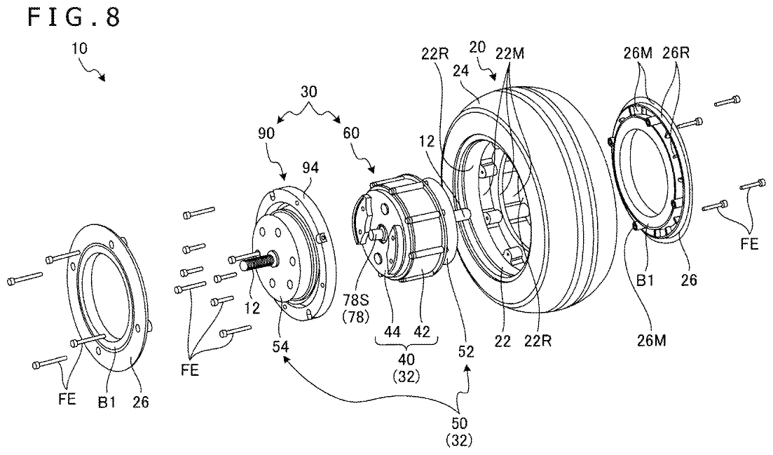

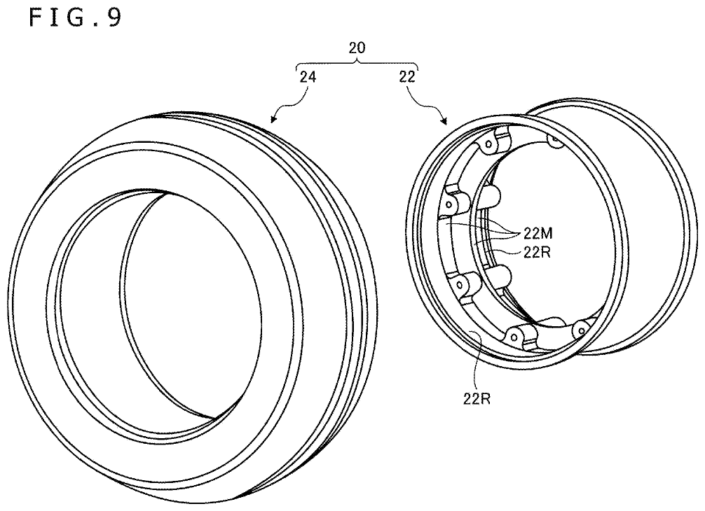

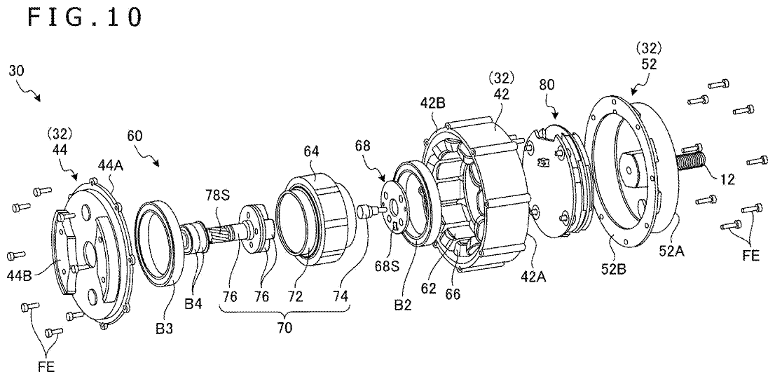

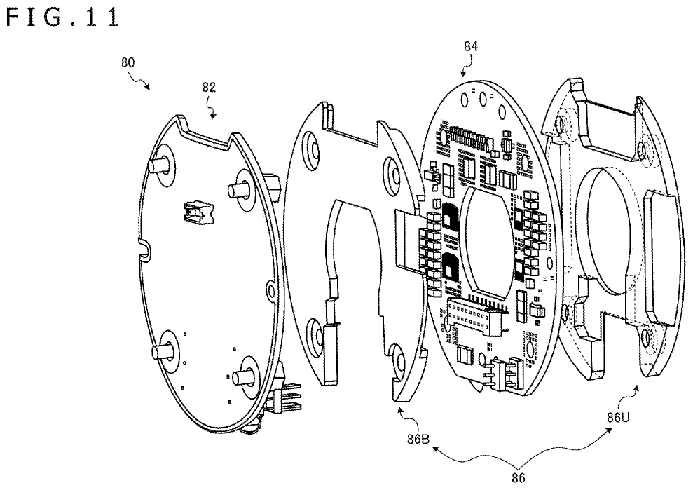

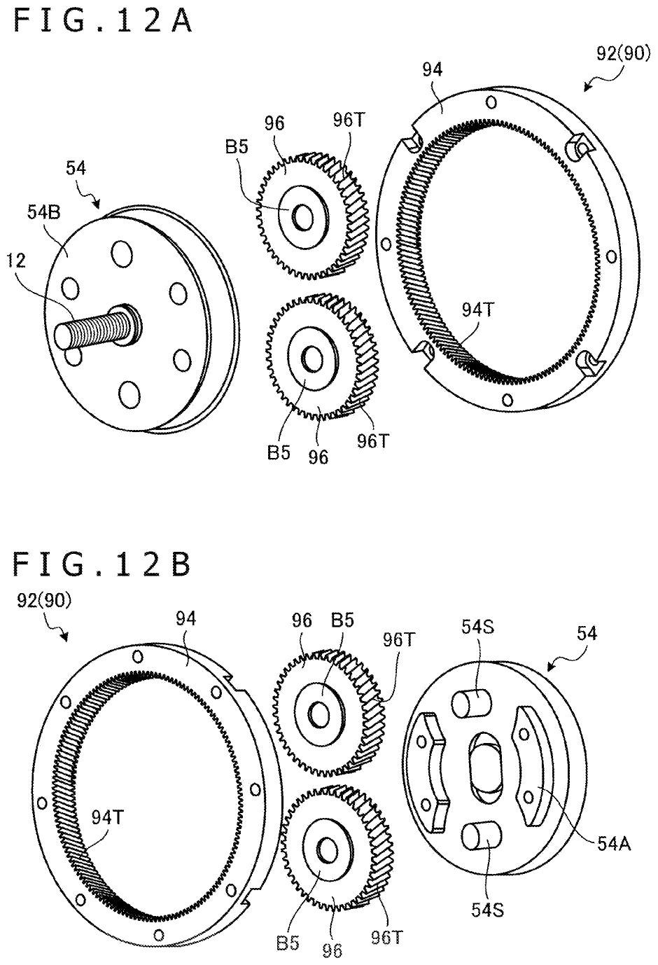

FIG. 7 is a sectional view of the electric wheel according to the first application mode. FIGS. 8 to 12 are exploded perspective views of the electric wheel according to the first application mode. The wheel section 20 has a rim 22, a tire 24, two side covers 26, and two first bearings B1. The driving device 30 has a housing 32, a motor section 60, a driving substrate 80, and a speed reduction gear 90.

The rim 22 has a cylindrical shape with a rotational axis R as a center axis. The rim 22 includes a rim main body 22M and a rim reinforcement section 22R. In the embodiment, the rim main body 22M includes a cylindrical section cylindrical in shape and a fixing section. To the fixing section, fixing members FE such as bolts for fixing the side covers 26 to the rim 22 are fixed. The rim main body 22 can be formed, for example, of a metallic member such as an aluminum alloy. The rim reinforcement section 22R is provided in a cylindrical shape such as to be along an inner circumferential surface of the cylindrical section of the rim main body 22M. The rim reinforcement section 22R can be formed by the above-mentioned multilayer structure 1. In other words, the rim main body 22M corresponds to the metallic material 2 depicted in FIG. 1. In the rim reinforcement section 22R, the first resin material 3 and the second resin material 4 are stacked on the rotational axis R side of the metallic material 2 which is the rim main body 22M. It is predicted that a compressive load in the vertical direction is exerted on the rim 22 in the first application mode. With the rim 22 provided with the rim reinforcement section 22R, a rise in deflection amount, a lowering in strength, and exfoliation can be restrained, even in a case where temperature is raised. The driving device 30 is provided in an inside space of the rim 22.

The tire 24 is fitted to the outside of the rim 22. The tire 24 can be formed, for example, of a member of a synthetic resin or the like. In the embodiment, the tire 24 is of eight inches (204 mm) in diameter and 75 mm in width.

The side covers 26 are provided such as to respectively cover both ends of the rim 22 in the direction of the rotational axis R. The side covers 26 have an annular shape having an inside diameter substantially equal to that of the rim 22. The side covers 26 are fixed to the rim 22 by the fixing members FE such as bolts. The side cover 26 includes a cover main body 26M and a cover reinforcement section 26R. In the embodiment, the cover main body 26M includes an annular section having an annular shape and a fixing section. To the fixing sections, the fixing members FE such as bolts for fixing the side covers 26 to the rim 22 are fixed. The cover main body 26M can be formed, for example, of a metallic member such as an aluminum alloy. The cover reinforcement section 26R has a rib shape formed on a surface on one side of the cover main body 26M. The cover reinforcement section 26R can be formed by the above-mentioned multilayer structure 1. In other words, the cover main body 26M corresponds to the metallic material 2 depicted in FIG. 1. In the cover reinforcement section 26R, the first resin material 3 and the second resin material 4 are stacked on an inner housing 40 side of the metallic material 2 which is the cover main body 26M. It is predicted that heat conduction of approximately 80° C. and a load of approximately 12 N are applied to the side covers 26 in the first application mode. With the side cover 26 provided with the cover reinforcement section 26R, a rise in deflection amount, a lowering in strength, and exfoliation can be restrained, even in the case where temperature is raised.

The first bearings B1 are provided respectively on the inside of the side covers 26. The first bearings B1 support the side covers 26 and the rim 22 of the wheel section 20 rotatably relative to the housing 32 of the driving device 30.

The housing 32 is provided on the inside of the rim 22, the side covers 26, and the first bearings B1. The housing 32 is supported relative to the support member 100 by the support section 14A and the support section 14B of the two fixed shafts 12. The housing 32 includes the inner housing 40 provided at a central section in the direction of the rotational axis R, and two outer housings 50 provided respectively adjacent to both sides of the inner housing 40 in the direction of the rotational axis R. The inner housing 40 includes a first inner housing 42 and a second inner housing 44. Of the two outer housings 50, one is a first outer housing 52, and the other is a second outer housing 54.

The first inner housing 42 is provided at a central part in the direction of the rotational axis R, on the inside of the rim 22. The first inner housing 42 has an outer circumferential surface provided spaced from an inner circumferential surface of the rim 22. The first inner housing 42 has a cylindrical shape with the rotational axis R as a center axis. The first inner housing 42 has an end face 42A that closes an end portion (a right end portion in FIG. 7) on one side in the direction of the rotational axis R. The first inner housing 42 has an end face 42B at an edge part of an end portion on the side opposite to the end face 42A. The first inner housing 42 is formed of a member having high thermal conductivity. The first inner housing 42 can be formed, for example, of a metal such as an aluminum alloy or a copper alloy. The first inner housing 42 accommodates the motor section 60 in cooperation with the second inner housing 44.

The second inner housing 44 is provided at the central part in the direction of the rotational axis R, on the inside of the rim 22. The second inner housing 44 has an outer circumferential surface provided spaced from an inner circumferential surface of the rim 22. The second inner housing 44 has a cylindrical shape with the rotational axis R as a center axis. The second inner housing 44 has a function as a lid for closing an end portion on the end face 42B side of the first inner housing 42. The second inner housing 44 has a flange-shaped end face 44A at an end portion on the first inner housing 42 side. The end face 44A is provided in face-face alignment with the end face 42B of the first inner housing 42. The second inner housing 44 is fixed to the first inner housing 42 at the end face 44A by the fixing members FE such as bolts. The second inner housing 44 has a projection 44B projecting to the side opposite to the end face 44A. The second inner housing 44 is formed of a member having high thermal conductivity. The second inner housing 44 can be formed, for example, of a metal such as an aluminum alloy or a copper alloy. The second inner housing 44 accommodates the motor section 60 in cooperation with the first inner housing 42.

The first outer housing 52 is provided adjacently to the inner housing 40 in the direction of the rotational axis R, on the inside of the first bearing B1. In the embodiment, the first outer housing 52 is provided adjacent to the first inner housing 42. The first outer housing 52 has a cylindrical shape with the rotational axis R as a center axis. The first outer housing 52 has a heat radiating surface 52A at an end portion on the side opposite to the first inner housing 42. The distance from the rotational axis R to an outer edge of the heat radiating surface 52A is equal to the distance from the rotational axis R to an inner circumferential surface of the first bearing B1. In the embodiment, the outside diameter of the heat radiating surface 52A is equal to the inside diameter of the first bearing B1. The heat radiating surface 52A is provided in face-face alignment with the support member 100. The first outer housing 52 has a flange-shaped end face 52B at an end portion on the first inner housing 42 side. The end face 52B is provided in face-face alignment with a part of the end face 42A of the first inner housing 42. The first outer housing 52 is fixed to the first inner housing 42 at the end face 52B by the fixing members FE such as bolts. The first outer housing 52 is fixed to the support section 14A of the fixed shaft 12. The first outer housing 52 is formed of a member having high thermal conductivity. The first outer housing 52 can be formed, for example, of a metal such as an aluminum alloy or a copper alloy.

The second outer housing 54 is provided adjacently to the inner housing 40 in the direction of the rotational axis R, on the inside of the first bearing B1. In the embodiment, the second outer housing 54 is provided adjacent to the second inner housing 44. The second outer housing 54 has a hollow cylindrical shape or a solid cylindrical shape with the rotational axis R as a center axis. The second outer housing 54 has a projection 54A projecting to the second inner housing 44 side. The projection 54A is provided in face-face alignment with the projection 44B of the second inner housing 44. The second outer housing 54 has a heat radiating surface 54B at an end portion on the side opposite to the second inner housing 44. The distance from the rotational axis R to an outer edge of the heat radiating surface 54B is equal to the distance from the rotational axis R to an inner circumferential surface of the first bearing B1. In the embodiment, the outside diameter of the heat radiating surface 54B is equal to the inside diameter of the first bearing B1. The heat radiating surface 54B is provided in face-face alignment with the support member 100. The second outer housing 54 is provided in face-face alignment with a part of the second inner housing 44. The second outer housing 54 is fixed to the support section 14B of the fixed shaft 12. The second outer housing 54 is formed of a member having high thermal conductivity. The first outer housing 52 can be formed, for example, of a metal such as an aluminum alloy or a copper alloy. The second outer housing 54 has a function as a fixed support member of the speed reduction gear 90 described later. The second outer housing 54 has two cylindrical support shafts 54S projecting to the second inner housing 44 side, at positions different from that of the projection 54A. The support shafts 54S support center shafts of planetary gears 96 of the speed reduction gear 90 described later.

The motor section 60 is accommodated in the inside of the first inner housing 42 and the second inner housing 44. The motor section 60 has a stator core 62, a rotor 64, a motor coil 66, an encoder substrate 68, and a first planetary gear mechanism 70. The first planetary gear mechanism 70 has a rotor inner gear 72, a sun gear 74, four planetary gears 76, a rotational support member 78, a second bearing B2, a third bearing B3, and a fourth bearing B4.

The stator core 62 has a cylindrical shape with the rotational axis R as a center axis. The distance from the rotational axis R to an inner circumferential surface of the stator core 62 is smaller than the distance from the rotational axis R to an outer edge of the heat radiating surface 52A of the first outer housing 52. In the embodiment, the inside diameter of the stator core 62 is smaller than the outside diameter of the heat radiating surface 52A of the first outer housing 52. The distance from the rotational axis R to the inner circumferential surface of the stator core 62 is smaller than the distance from the rotational axis R to an outer edge of the heat radiating surface 54B of the second outer housing 54. In the embodiment, the inside diameter of the stator core 62 is smaller than the outside diameter of the heat radiating surface 54B of the second outer housing 54. The stator core 62 is provided to be fitted to the inside of the first inner housing 42. An outer circumferential surface of the stator core 62 and an inner circumferential surface of the first inner housing 42 are in face-face alignment. The stator core 62 is formed of electromagnetic steel sheet. The stator core 62 can be formed, for example, from iron, nickel, and cobalt.

The rotor 64 has a cylindrical shape with the rotational axis R as a center axis. The rotor 64 is provided inside the stator core 62. The rotor 64 has magnets embedded evenly on the circumference of a circle of the rotor 64.

The motor coil 66 is wound around between plural grooves formed in the stator core 62. With a current flowing in the motor coil 66, an electromagnetic force is generated between the stator core 62 and the rotor 64, whereby the rotor 64 is rotated around the rotational axis R.

The rotor inner gear 72 has a cylindrical shape with the rotational axis R as a center axis. The rotor inner gear 72 is provided to be fitted to the inside of the rotor 64. The width of the rotor inner gear 72 in the direction of the rotational axis R is greater than the width of the rotor 64 in the direction of the rotational axis R. The rotor inner gear 72 is supported rotatably relative to the first inner housing 42 through the second bearing B2. The rotor inner gear 72 is rotated as one body with the rotor 64. The rotor inner gear 72 is supported rotatably relative to the second inner housing 44 through the third bearing B3. The rotor inner gear 72 has a tooth section 72T at a part of an inner circumferential surface thereof. The rotor inner gear 72 has a wall section 72W extending from the inner circumferential surface toward the rotational axis R side, on the first outer housing 52 side relative to the tooth section 72T.

The sun gear 74 has the rotational axis R as a center axis. The sun gear 74 is provided inside the rotor inner gear 72. The sun gear 74 is provided to be fixed on the end face 42A side of the first inner housing 42. The sun gear 74 has a tooth section 74T at a part of an outer circumferential surface thereof.

The four planetary gears 76 are provided evenly on the outer circumference of the sun gear 74. The planetary gears 76 are provided respectively between the tooth section 72T of the rotor inner gear 72 and the tooth section 74T of the sun gear 74. The planetary gear 76 has a tooth section 76T at an outer circumferential surface thereof. The tooth sections 76T of the planetary gears 76 mesh respectively with the tooth section 72T of the rotor inner gear 72 and the tooth section 74T of the sun gear 74. Attendant on the rotation of the rotor inner gear 72, the planetary gears 76 revolve in the same direction around the sun gear 74 while rotating in the same direction as that of the rotor inner gear 72. While the four planetary gears 76 are provided in the embodiment, the number of the planetary gears 76 is not limited to four.

The rotational support member 78 has the rotational axis R as a center axis. The rotational support member 78 is supported rotatably relative to the second inner housing 44 through the fourth bearing B4. The rotational support member 78 has a support shaft 78F that fixes the planetary gears 76. The rotational support member 78 rotates attendant on the revolution of the planetary gears 76. The rotational support member 78 is provided as one body with an output shaft 78S of the motor section 60. The output shaft 78S is provided to project from an end face on the second outer housing 54 side of the second inner housing 44. The output shaft 78S has a tooth section 78T at an outer circumferential surface thereof. The output shaft 78S has a function as a sun gear of the speed reduction gear 90 described later.

The encoder substrate 68 has a disk shape orthogonal to the rotational axis R. The encoder substrate 68 is provided to be fixed to the first inner housing 42, inside the rotor inner gear 72 and on the first outer housing 52 side relative to the wall section 72W. The encoder substrate 68 is provided with a sensor integrated circuit 68C on a surface on the wall section 72W side. The sensor integrated circuit 68C is a magnetic-type rotation detecting sensor. The sensor integrated circuit 68C detects the rotation number and the rotational speed of the rotor inner gear 72. The rotor inner gear 72 is rotated as one body with the rotor 64. Therefore, by detecting the rotation number and the rotational speed of the rotor inner gear 72, the sensor integrated circuit 68C can detect the rotation number and the rotational speed of the rotor 64. The sensor integrated circuit 68C is shielded from the magnetism generated by the rotor 64, by the wall section 72W. As a result, the encoder substrate 68 can be provided inside the rotor 64, which can contribute to a reduction in size of the driving device 30.

The driving substrate 80 is provided inside the first outer housing 52. The driving substrate 80 is provided in the state of being spaced from the motor section 60 which is accommodated in the first inner housing 42 and the second inner housing 44. The driving substrate 80 has a first substrate 82, a second substrate 84, and two heat diffusing plates 86. In the embodiment, the driving substrate 80 is of a two-story structure in which the first substrate 82 and the second substrate 84 are juxtaposed. While the driving substrate 80 may be one sheet, the two-story structure of the driving substrate 80 can contribute to a reduction in size of the driving device 30 and the electric wheel 10. In addition, the driving substrate 80 may be provided outside the housing 32. For example, the driving substrate 80 may be provided inside another housing to be attached to a frame of a two-wheeled vehicle on which the electric wheel 10 is mounted. In a case where the driving substrate 80 is not provided in the housing 32, the first inner housing 42 and the first outer housing 52 may be provided as one body.

The first substrate 82 has a disk shape orthogonal to the rotational axis R. The first substrate 82 includes an arithmetic processing section for controlling the driving of the motor section 60 on the basis of a predetermined arithmetic program. The arithmetic processing section controls the driving of the motor section 60 on the basis of the rotation number and the rotational speed of the rotor inner gear 72 detected by the sensor integrated circuit 68C of the encoder substrate 68. The arithmetic processing section is, for example, a CPU (Central Processing Unit).

The second substrate 84 has a disk shape orthogonal to the rotational axis R. The second substrate 84 includes an electric power control section for controlling the electric power for passing a current to the motor coil 66. The electric power control section, the second substrate 84 includes a power semiconductor. The second substrate 84 is provided on the heat radiating surface 52A side relative to the first substrate 82.

The heat diffusing plate 86 is an integrated heat spreader. The integrated heat spreader has a structure for diffusing heat to enhance a heat radiating effect. The heat diffusing plate 86 has a first heat diffusing plate 86B and a second heat diffusing plate 86U. The first heat diffusing plate 86B is provided between the first substrate 82 and the second substrate 84. The second heat diffusing plate 86U is provided adjacently to the heat radiating surface 52A side of the first outer housing 52 relative to the second substrate 84. The second heat diffusing plate 86U has at least a part thereof fixed in face-face alignment to the inside of the first outer housing 52. The heat diffusing plate 86 is formed of a member having high thermal conductivity. The heat diffusing plate 86 can be formed, for example, of a metal such as an aluminum alloy or a copper alloy.

The speed reduction gear 90 includes a second planetary gear mechanism 92. The second planetary gear mechanism 92 has the output shaft 78S of the rotational support member 78, an inner gear 94, the two planetary gears 96, the second outer housing 54, and a fifth bearing B5. The output shaft 78S has a function as a sun gear in the second planetary gear mechanism 92. The second outer housing 54 has a function as a fixed support member in the second planetary gear mechanism 92.

The inner gear 94 has a cylindrical shape with the rotational axis R as a center axis. The inner gear 94 has an inside diameter substantially the same as that of the rim 22. The inner gear 94 is provided between the second inner housing 44 and the second outer housing 54 in the direction of the rotational axis R. The inner gear 94 is fixed to the rim 22 by the fixing members FE such as bolts. The inner gear 94 has a tooth section 94T at an inner circumferential surface thereof.

The planetary gear 96 has a disk shape with a through-hole in the center. The two planetary gears 96 are provided in point symmetry on an outer circumference of the output shaft 78S. The planetary gears 96 are provided respectively between the tooth section 94T of the inner gear 94 and the tooth section 78T of the output shaft 78S. The planetary gear 96 has a tooth section 96T at an outer circumferential surface thereof. The tooth sections 96T of the planetary gears 96 mesh respectively with the tooth section 94T of the inner gear 94 and the tooth section 78T of the output shaft 78S. The fifth bearing B5 is provided on the inside of the planetary gear 96. The planetary gears 96 are fixed to the support shaft 54S of the second outer housing 54 through the fifth bearing B5. Attendant on the rotation of the output shaft 78S, the planetary gears 96 rotate in the direction opposite to the rotation of the output shaft 78S. Attendant on the rotation of the planetary gears 96, the inner gear 94 and the rim 22 rotate in the direction opposite to the rotation of the output shaft 78S. The number of the planetary gears 96 is not limited to two, and three or more planetary gears may be provided. In a case where the number of the planetary gears 96 is two, the projection 44B of the second inner housing 44 and the projection 54A of the second outer housing 54 can be set larger, as compared to a case where three or more planetary gears 96 are provided.

[Heat Transfer Path of Electric Wheel according to First Application Mode]

Next, a heat transfer path in the driving device 30 and the electric wheel 10 according to an embodiment of the present disclosure will be described with reference to FIG. 7. When a current is passed through the motor coil 66 by the control of the driving substrate 80, Joule's heat is generated by electric resistance of the motor coil 66. In other words, a main heat transfer source of the driving device 30 is the motor coil 66. As illustrated in FIG. 7, the motor coil 66 is disposed substantially in the center of the electric wheel 10 in the direction of the rotational axis R. In the driving device 30 and the electric wheel 10 of the present disclosure, heat is radiated from the heat radiating surface 52A and the heat radiating surface 54B provided at both end portions of the housing 32 in the direction of the rotational axis R.

First, a heat transfer path from the motor coil 66 to the first inner housing 42 will be described. The motor coil 66 is wound around the stator core 62. As a result, the stator core 62 receives the heat of the motor coil 66 which is a heat transfer source. An outer circumferential surface of the stator core 62 and an inner circumferential surface of the first inner housing 42 are provided in face-face alignment. In addition, the first inner housing 42 is formed of a member having high thermal conductivity. As a result, the heat transferred to the stator core 62 is transferred to the first inner housing 42.

Next, a heat transfer path from the first inner housing 42 to the heat radiating surface 52A will be described. The end face 42A of the first inner housing 42 and the end face 52B of the first outer housing 52 are provided in face-face alignment. The end face 52B of the first outer housing 52, by being provided in a flange shape at an end portion on the first inner housing 42 side, is enlarged in the contact surface thereof with the end face 42A of the first inner housing 42. In addition, the first outer housing 52 is formed of a member having high thermal conductivity. As a result, the heat transferred to the first inner housing 42 is efficiently transferred to the first outer housing 52.

The heat radiating surface 52A of the first outer housing 52 and the support member 100 are provided in face-face alignment. As a result, the heat transferred to the first outer housing 52 is radiated to the support member 100 through the heat radiating surface 52A. In a case where the support member 100 is not configured in face-face alignment with the heat radiating surface 52A, the heat is directly radiated to the outside air from the heat radiating surface 52A. The outside diameter of the heat radiating surface 52A is equal to the inside diameter of the first bearing B1 and is greater than the inside diameter of the stator core 62. With the heat radiating surface 52A enlarged, efficient heat radiation can be realized.

Next, a heat transfer path from the first inner housing 42 to the heat radiating surface 54B will be described. The end face 42B of the first inner housing 42 and the end face 44A of the second inner housing 44 are provided in face-face alignment. The end face 44A of the second inner housing 44, by being provided in a flange shape at an end portion on the first inner housing 42 side, is enlarged in the contact surface thereof with the end face 42B of the first inner housing 42. In addition, the second inner housing 44 is formed of a member having high thermal conductivity. As a result, the heat transferred to the first inner housing 42 is efficiently transferred to the second inner housing 44.

The projection 44B of the second inner housing 44 and the projection 54A of the second outer housing 54 are provided in face-face alignment. In the embodiment, the number of the planetary gears 96 provided between the second outer housing 54 and the second inner housing 44 is two. As a result, since the projection 44B of the second inner housing 44 and the projection 54A of the second outer housing 54 can be provided to be large, the contact surface between the projection 44B and the projection 54A can be enlarged. As a result, the heat transferred to the second inner housing 44 can be efficiently transferred to the second outer housing 54.

The heat radiating surface 54B of the second outer housing 54 and the support member 100 are provided in face-face alignment. As a result, the heat transferred to the second outer housing 54 is radiated to the support member 100 through the heat radiating surface 54B. In a case where the support member 100 is not in face-face alignment with the heat radiating surface 54B, the heat is directly radiated to the outside air from the heat radiating surface 54B. The outside diameter of the heat radiating surface 54B is equal to the inside diameter of the first bearing B1 and is greater than the inside diameter of the stator core 62. With the heat radiating surface 54B enlarged, efficient heat radiation can be achieved.

Thus, in the driving device 30 and the electric wheel 10 of the present disclosure, in the housing 32 that accommodates the motor coil 66, heat is radiated from the sides of the driving substrate 80 and the speed reduction gear 90 which are located on the outermost side. With the areas of the heat radiating surface 52A on the driving substrate 80 side and the heat radiating surface 54B on the speed reduction gear 90 side enlarged, heat can be radiated efficiently. Since a cooling part is not needed for heat radiation, maintenance such as replacement and replenishment of the cooling part is unnecessary. In the embodiment, since heat is transferred to both sides of the housing 32 and is radiated from both the heat radiating surface 52A and the heat radiating surface 54B which are both end portions of the housing 32, more efficient heat radiation can be realized. Since the heat transfer path from the stator core 62 to the heat radiating surface 52A and the heat radiating surface 54B is connected by continuous solid members without being intermediated by an air layer which is low in heat transfer coefficient, heat can be efficiently transferred to the heat radiating surface 52A and the heat radiating surface 54B. Further, since the first inner housing 42, the first outer housing 52, the second inner housing 44, and the second outer housing 54 constituting the transfer path are formed of members having high thermal conductivity, heat can be efficiently transferred.

When a current is passed to the motor coil 66 under control of the driving substrate 80, Joule's heat is generated in the first substrate 82 and the second substrate 84 by electric resistance. The first substrate 82 transfers the heat to the first heat diffusing plate 86B. The second substrate 84 transfers the heat to the first heat diffusing plate 86B and the second heat diffusing plate 86U. The first heat diffusing plate 86B and the second heat diffusing plate 86U diffuse heat, thereby to enhance the heat radiating effect. The second heat diffusing plate 86U and the inside of the first outer housing 52 are provided partly in face-face alignment. As a result, the heat transferred to the second heat diffusing plate 86U is transferred to the first outer housing 52. The heat transferred to the second outer housing 54 is radiated to the support member 100 through the heat radiating surface 54B. The driving substrate 80 generates more heat at the second substrate 84 which performs control of electric power. By providing the second substrate 84 further on the heat radiating surface 52A side than the first substrate 82, heat can be efficiently radiated. In addition, by providing the second substrate 84 to be spaced from the motor coil 66 which is a main heat transfer source, a rise in temperature can be restrained.

[Deformation Strength of Electric Wheel according to First Application Mode]

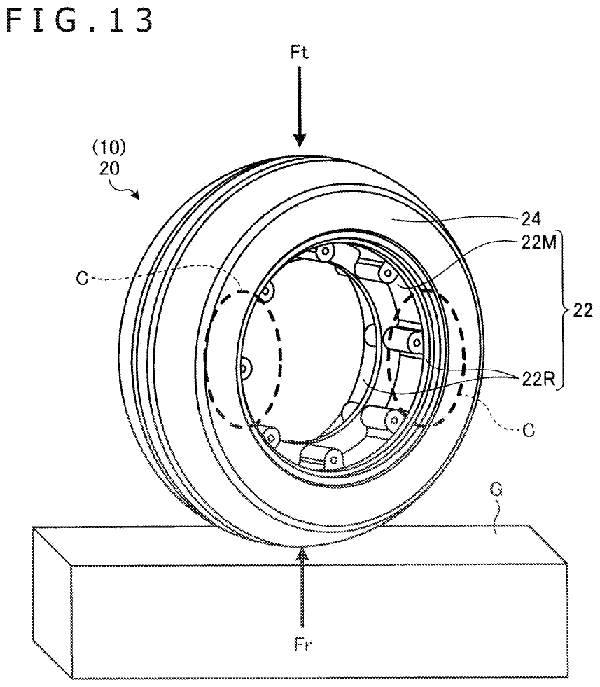

Next, strength against deformation of the wheel section 20 of the electric wheel 10 to which the multilayer structure 1 according to the present disclosure is applied will be described. FIG. 13 is a perspective view of the electric wheel according to the first application mode. Note that, in FIG. 13, of the electric wheel 10, other parts than the wheel section 20 are omitted from illustration.

When the electric wheel 10 travels on a ground G, the wheel section 20 receives a load Ft from the vehicle connected to the electric wheel 10 through the electric wheel 10 and the support member 100 (see FIG. 1). The wheel section 20 receives a reaction force Fr of the load Ft from the ground G. Since the wheel section 20 receives compressive forces in the upward and downward directions, the rim 22 is compressed at a compressed section C in a central part in the vertical direction. In this instance, in the rim reinforcement section 22R, the carbon fibers contained in the second resin material 4 stretch in the circumferential direction, whereby a rise in deflection amount, a lowering in strength, and exfoliation due to the vertical compression of the rim 22 can be restrained.

While the first application mode of the present disclosure has been described above, the technical scope of the present disclosure is not limited to the above-mentioned first application mode as it is, and various modifications are possible within such ranges as not to depart from the gist of the present disclosure.

In the above-mentioned first application mode, a case on the premise that heat is radiated from both the heat radiating surface 52A and the heat radiating surface 54B provided at both end portions of the housing 32 in the direction of the rotational axis R has been described, but this is not limitative. The heat radiating surface may be provided on only one side of the housing 32.

In the above-mentioned first application mode, a case on the premise that the first inner housing 42 is provided in a cylindrical shape and the second inner housing 44 has a function as a lid for the first inner housing 42 has been described, but this is not limitative. For example, the second inner housing 44 may be provided in a cylindrical shape, and the stator core 62 may be provided to be fitted to the inside of the second inner housing 44. In this case, the heat transferred from the motor coil 66 to the stator core 62 is first transferred to the second inner housing 44, and is then transferred to the first inner housing 42 and the second outer housing 54.

In the above-mentioned first application mode, a case on the premise that all the heat transfer path is configured by solid members has been described, but this is not limitative. For example, for increasing the heat transfer path or filling a minute gap by assembly, at least a part of the inside of the housing 32 may be filled with an insulating heat radiating agent. The insulating heat radiating agent is, for example, a grease mixed with particles having high thermal conductivity.

In the above-mentioned first application mode, while an example in which the electric wheel 10 is applied to a two-wheeled vehicle such as an electric kick board has been described, the electric wheel 10 may be applied, for example, to a skater, an automatic conveying robot, a car truck, an automobile, a wheelchair, or the like.

### (Second Application Mode)

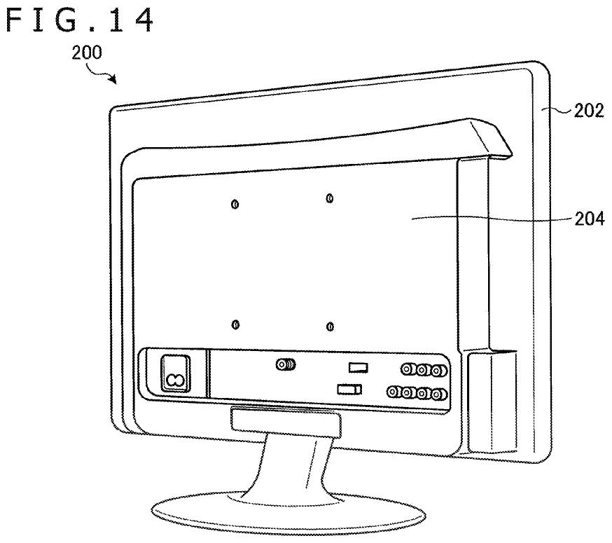

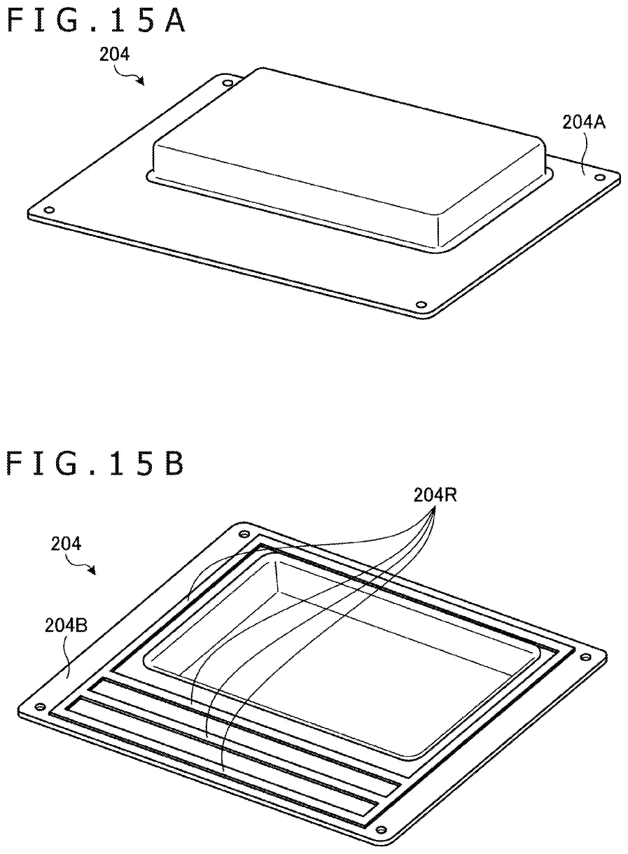

Next, a configuration of a television set 200 to which the multilayer structure 1 according to the present disclosure is applied will be described. FIG. 14 is a schematic diagram depicting a television set according to the second application mode of the present disclosure. FIGS. 15A and 15B are schematic diagrams depicting a back cover of the second application mode.

In the second application mode, the television set 200 includes a television set main body 202 and a back cover 204. The television set main body 202 includes a substrate including an arithmetic processing section for controlling the television set 200, an electric power control section for controlling electric power, and the like.

The back cover 204 is provided covering the back surface of the television set main body 202. The back cover 204 is fixed to the television set main body 202. The substrate and the like provided in the television set main body 202 are accommodated in the inside of the back cover 204. The back cover 204 can be formed, for example, of a metallic member such as an aluminum alloy. The back cover 204 includes a reinforcement section 204R at a back surface 204B on the side opposite to the back surface 204A of the television set 200.

The reinforcement section 204R has a rib shape formed at the back surface 204B of the back cover 204. The reinforcement section 204R can be formed by the above-mentioned multilayer structure 1. In other words, the back cover 204 corresponds to the metallic material 2 depicted in FIG. 1. In the reinforcement section 204R, the first resin material 3 and the second resin material 4 are stacked on the television set main body 202 side of the metallic material 2 which is the back cover 204. It is predicted that the back cover 204 of the second application mode undergoes a rise in temperature due to heat generation by the substrate and the like. The back cover 204 can be provided to be light in weight and high in strength while having high thermal conductivity, by applying the multilayer structure 1 to the reinforcement section 204R. By providing the reinforcement section 204R, the back cover 204 can restrain a rise in deflection amount, a lowering in strength, and exfoliation, even in the case where temperature is raised.

### (Third Application Mode)

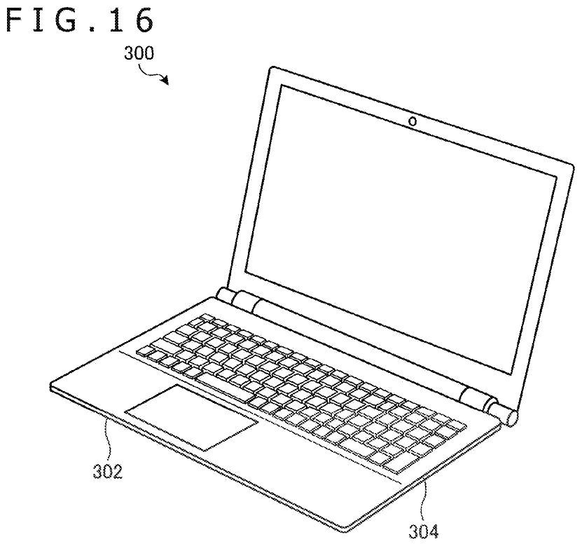

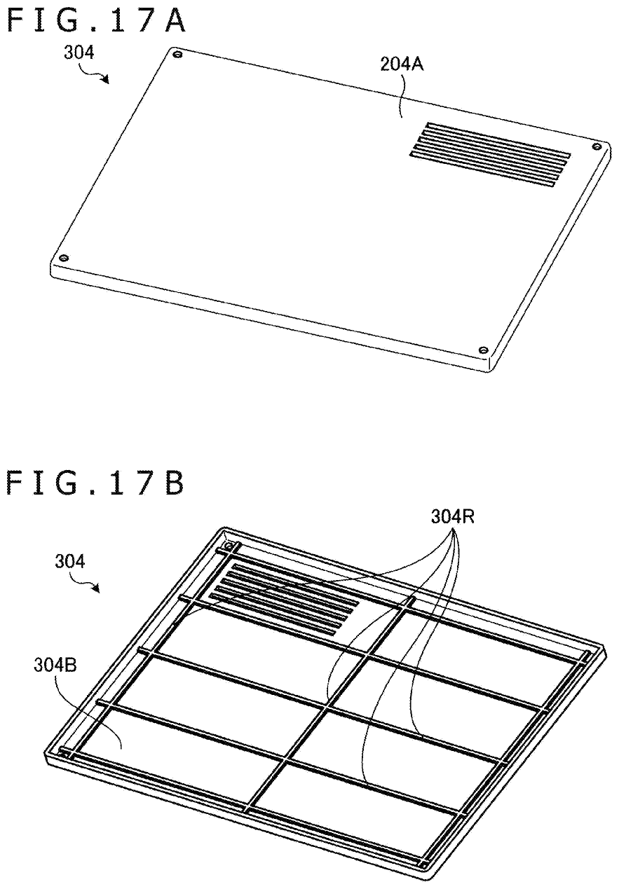

Next, a configuration of a notebook personal computer 300 to which the multilayer structure 1 according to the present disclosure is applied will be described. FIG. 16 is a schematic diagram depicting a notebook personal computer according to a third application mode of the present disclosure. FIGS. 17A and 17B are schematic diagrams depicting a bottom cover of the third application mode.

In the third application mode, the notebook personal computer 300 includes a personal computer main body 302 and a bottom cover 304. The personal computer main body 302 includes a substrate including an arithmetic processing section for controlling the notebook personal computer 300, an electric power control section for controlling electric power, and the like and a battery and the like.

The bottom cover 304 is provided covering a bottom surface of the personal computer main body 302. The bottom cover 304 is fixed to the personal computer main body 302. The substrate, the battery, and the like provided in the personal computer main body 302 are accommodated in the inside of the bottom cover 304. The personal computer main body 302 can be formed, for example, of a metallic member such as an aluminum alloy. The bottom cover 304 includes a reinforcement section 304R at a back surface 304B on the side opposite to the bottom surface 304A of the notebook personal computer 300.

The reinforcement section 304R has a rib shape formed at the back surface 304B of the bottom cover 304. The reinforcement section 304R can be formed by the above-mentioned multilayer structure 1. In other words, the bottom cover 304 corresponds to the metallic material 2 depicted in FIG. 1. In the reinforcement section 204R, the first resin material 3 and the second resin material 4 are stacked on the personal computer main body 302 side of the metallic material 2 which is the bottom cover 304. It is predicted that the bottom cover 304 of the third application mode undergoes a rise in temperature due to heat generation by the substrate, the battery, and the like. By applying the multilayer structure 1 to the reinforcement section 304R, the bottom cover 304 can be provided to be light in weight and high in strength while having high thermal conductivity. By providing the reinforcement section 304R, the bottom cover 304 can restrain a rise in deflection amount, a lowering in strength, and exfoliation, even in the case where temperature is raised.

While the embodiment and each application mode of the present disclosure have been described above, the technical scope of the present disclosure is not limited to the above-mentioned modes as they are, and various modifications are possible in such ranges as not to depart from the gist of the present disclosure.

### (Effects)

The multilayer structure 1 includes the metallic material 2, the thermoplastic first resin material 3 bonded to the metallic material 2, and the thermoplastic second resin material 4 that is bonded to the first resin material 3 and contains carbon, the metallic material 2, the thermoplastic first resin material 3, and the thermoplastic second resin material 4 being stacked on one another.

As a result, the multilayer structure 1 has the layer of the first resin material 3 formed between the metallic material 2 and the second resin material 4 to bond the latter two, and, therefore, it is unnecessary to use an adhesive which is liable to be deteriorated by aging and environments such as temperature. Therefore, the multilayer structure 1 is high in reliability of bonding and can maintain high strength. Since the metallic material 2 contributes to high thermal conductivity and the first resin material 3 and the second resin material 4 contribute to a reduction in weight and enhancement of strength, the multilayer structure 1 has high thermal conductivity and can be applied to parts requiring lightness in weight and high strength characteristics.

The multilayer structure 1 has the first resin material 3 bonded to the metallic material 2 by insert molding.

As a result, the multilayer structure 1 can bond firmly the metallic material 2 and the first resin material 3.

The multilayer structure 1 has the second resin material 4 bonded to the first resin material 3 by heat welding or hot pressing.

As a result, the multilayer structure 1 can bond firmly the first resin material 3 and the second resin material 4.

The multilayer structure 1 has the first resin material 3 bonded to the metallic material 2 and the second resin material 4 by simultaneous insert molding.

As a result, the multilayer structure 1 can bond firmly the metallic material 2 and the first resin material 3 and can bond firmly the first resin material 3 and the second resin material 4.

The multilayer structure 1 has the components of the second resin material 4 which are the same as the components of the first resin material 3.

As a result, the multilayer structure 1 can bond more firmly the first resin material 3 and the second resin material 4.

The driving device 30 includes the multilayer structure 1 including the metallic material 2, the thermoplastic first resin material 3 bonded to the metallic material 2, and the thermoplastic second resin material 4 that is bonded to the first resin material 3 and contains carbon, and further includes the wheel section 20 rotated around the rotational axis R, the housing 32 that is supported in the inside space of the wheel section 20 by the two support members 100 on the rotational axis R and includes the heat radiating surface 52A or 54B at an end portion on at least one side in the direction of the rotational axis R, and the stator core 62 that is supported between the two support members 100 and inside the housing 32 and has an inner circumferential surface of which the distance from the rotational axis R is smaller than the distance from the rotational axis R to an outer edge portion of the heat radiating surface 52A or 54B.

As a result, by including the multilayer structure 1 at a portion of the parts, the driving device 30 can contribute to a reduction in weight and enhancement of strength while having high thermal conductivity. In addition, by enlarging the areas of the heat radiating surfaces 52A and 54B which are end portions of the housing 32, the driving device 30 can radiate heat efficiently.

The driving device 30 has the wheel section 20 having the rim 22 which includes the rim reinforcement section 22R which is the multilayer structure 1.

As a result, by providing the rim 22 with the rim reinforcement section 22R, the driving device 30 can restrain a rise in deflection amount, a lowering in strength, and exfoliation in the rim 22, even in the case where temperature is raised.

The driving device 30 has the rim reinforcement section 22R including the cylindrical shape provided along an inner circumferential surface of the rim 22.

As a result, with the rim reinforcement section 22R provided along the inner circumferential surface of the rim 22, the carbon fibers stretch in the circumferential direction in a central part in the vertical direction of the rim 22, so that the driving device 30 can restrain a rise in deflection amount, a lowering in strength, and exfoliation due to compression in the vertical direction of the rim 22.

The driving device 30 has the wheel sections 20 provided such as to respectively cover both ends of the rim 22 in the direction of the rotational axis R and has the side cover 26 including the cover reinforcement section 26R which is the multilayer structure 1.

As a result, by providing the side cover 26 with the cover reinforcement section 26R, the driving device 30 can restrain a rise in deflection amount, a lowering in strength, and exfoliation in the side cover 26, even in the case where temperature is raised.

The driving device 30 has the cover reinforcement section 26R including the rib shape formed on the surface on the inside of the side cover 26 in the direction of the rotational axis R.

As a result, with the rib-shaped cover reinforcement section 26R formed on the surface on the inside of the side cover 26, the driving device 30 can restrain a rise in deflection amount, a lowering in strength, and exfoliation.

The driving device 30 has the heat transfer path of the continuous solid members from the stator core 62 to the heat radiating surfaces 52A and 54B.

As a result, since the heat transfer path from the stator core 62 to the heat radiating surface 52A and the heat radiating surface 54B is connected by the continuous solid members without being intermediated by an air layer which is low in heat transfer coefficient, the driving device 30 can efficiently transfer heat to the heat radiating surface 52A and the heat radiating surface 54B.

The driving device 30 has the housing 32 including the heat radiating surfaces 52A and 54B at both end portions in the direction of the rotational axis R.

As a result, since heat is radiated from both the heat radiating surface 52A and the heat radiating surface 54B which are both end portions of the housing 32, the driving device 30 can radiate heat more efficiently.

The driving device 30 has an outer circumferential surface of the stator core 62 supported in face-face alignment with an inner circumferential surface of the housing 32.

As a result, since the contact surface between the stator core 62 and the housing 32 can be enlarged, the driving device 30 can efficiently transfer, to the housing 32, the heat transferred to the stator core 62.

The driving device 30 has the driving substrate 80 that is accommodated in the inside of the housing 32 and controls the electromagnetic force generated in the stator core 62.

As a result, the driving device 30 can simplify the configuration of electrical connection between the stator core 62 and the driving substrate 80.

The driving device 30 has the driving substrate 80 having the first substrate 82 that includes the arithmetic processing section for executing a predetermined arithmetic program and the second substrate 84 that includes an electric power control section provided further on the heat radiating surface 52A side than the first substrate 82 and performing control of electric power.

As a result, by providing the second substrate 84, which generates more heat by performing control of electric power, further on the heat radiating surface 52A side than the first substrate 82, the driving device 30 can radiate heat efficiently. In addition, by providing the second substrate 84 at a position spaced from the stator core 62 on which the motor coil 66 as a main heat transfer source is wound, the driving device 30 can restrain a rise in temperature. Besides, since the driving substrate 80 is of a two-story structure of the first substrate 82 and the second substrate 84, the driving device 30 can contribute to a reduction in size.

The driving device 30 has the driving substrate 80 that is provided adjacently to the heat radiating surface 52A side relative to the second substrate 84 and that has the heat diffusing plate 86 having at least a part thereof fixed in face-face alignment with the inside of the housing 32.

As a result, the driving device 30 can diffuse the heat generated in the driving substrate 80 by the heat diffusing plate 86 to thereby enhance the heat radiating effect. In addition, the driving device 30 can efficiently transfer, to the housing 32, the heat transferred to the heat diffusing plate 86.

The driving device 30 has the housing 32 that has the inner housing 40 accommodating the stator core 62 and the first outer housing 52 accommodating the driving substrate 80 and including the heat radiating surface 52A.

As a result, by providing the driving substrate 80 at a position spaced from the stator core 62 on which the motor coil 66 as a main heat transfer source is wound, the driving device 30 can restrain a rise in temperature.

The driving device 30 has the first outer housing 52 fixed in face-face alignment with the end face 42A of the inner housing 40 in the direction of the rotational axis R.

As a result, the driving device 30 can enlarge the contact surface between the inner housing 40 and the first outer housing 52 and thus can efficiently transfer, to the first outer housing 52, the heat transferred to the inner housing 40.

The driving device 30 has the speed reduction gear 90 that is provided on the opposite side of the stator core 62 from the driving substrate 80 and that includes the heat radiating surface 54B.

As a result, the driving device 30 can efficiently radiate the heat from the heat radiating surface 54B of the speed reduction gear 90.

The driving device 30 has the speed reduction gear 90 having the output shaft 78S projecting to the exterior of the inner housing 40 and outputting rotation of the rotor 64 for rotating by the magnetism of the stator core 62, the inner gear 94 fixed to the wheel section 20, and the planetary gears 96 meshing with the output shaft 78S and the inner gear 94. The driving device 30 also has the housing 32 having the second outer housing 54 that is provided on the opposite side of the inner housing 40 from the first outer housing 52, supporting rotary shafts of the planetary gears 96, and including the heat radiating surface 54B.

As a result, the driving device 30 can radiate heat efficiently from the heat radiating surface 54B of the speed reduction gear 90.

The driving device 30 has the two planetary gears 96.

As a result, the driving device 30 can provide the large contact surface between the inner housing 40 and the second outer housing 54. By providing the large contact surface between the inner housing 40 and the second outer housing 54, the driving device 30 can efficiently transfer, to the second outer housing 54, the heat transferred to the inner housing 40.

The driving device 30 has the second outer housing 54 provided in face-face alignment with at least a part of the end portion of the inner housing 40 in the direction of the rotational axis R.

As a result, the driving device 30 can efficiently transfer, to the second outer housing 54, the heat transferred to the inner housing 40.

The driving device 30 has the sensor integrated circuit 68C that is supported in the inside of the rotor 64 rotated by the magnetism of the stator core 62 and detects rotation of the rotor 64 and the wall section 72W that shield the magnetism of the stator core 62 and the rotor 64 from the sensor integrated circuit 68C.

As a result, since the sensor integrated circuit 68C can be provided in the inside of the rotor 64, the driving device 30 can contribute to a reduction in size of the driving device 30.

The electric wheel 10 includes the housing 32 including the heat radiating surface 52A or 54B at the end portion on at least one side in the direction of the rotational axis R; the two fixed shafts 12 coaxial with the rotational axis R and supporting the housing 32; the stator core 62 that is supported in the inside of the housing 32 and has the inner circumferential surface of which the distance from the rotational axis R is smaller than the distance from the rotational axis R to an outer edge of the heat radiating surface 52A or 54B; and the wheel section 20 that has the multilayer structure 1 having the metallic material 2, the thermoplastic first resin material 3 bonded to the metallic material 2, and the thermoplastic second resin material 4 that is bonded to the first resin material 3 and contains carbon, the wheel section 20 accommodating the housing 32 in an inside space thereof and is rotated around the rotational axis R.

As a result, by including the multilayer structure 1 at a portion of the parts, the electric wheel 10 can contribute to a reduction in weight and enhancement of strength while having high thermal conductivity. In addition, by enlarging the areas of the heat radiating surfaces 52A and 54B which are end portions of the housing 32, the driving device 30 can radiate heat efficiently.

The electric wheel 10 has the heat radiating surfaces 52A and 54B fixed in face-face alignment with the support member 100 holding the fixed shaft 12.

As a result, the electric wheel 10 can efficiently transfer, to the support member 100, the heat transferred to the heat radiating surfaces 52A and 54B.

The electric wheel 10 has the wheel section 20 connected to the outer circumferential surface of the housing 32 through the first bearing B1, at the end portion in the direction of the rotational axis R, and the distance from the rotational axis R to an outer edge of the heat radiating surface 52A or 54B is equal to the distance from the rotational axis R to the inner circumferential surface of the first bearing B1.

As a result, by enlarging the areas of the heat radiating surfaces 52A and 54B which are end portions of the housing 32, the electric wheel 10 can radiate heat more efficiently.

Note that the effects described herein are merely examples and are not limitative, and other effects may be present.

Note that the present technology can also take the following configurations.
(1)

A multilayer structure including:

a metallic material;

a thermoplastic first resin material bonded to the metallic material; and

a thermoplastic second resin material that is bonded to the first resin material and contains carbon,

the metallic material, the thermoplastic first resin material, and the thermoplastic second resin material being stacked on one another.
(2)

The multilayer structure according to (1) above,

in which the first resin material is bonded to the metallic material by insert molding.
(3)

The multilayer structure according to (1) or (2) above,

in which the second resin material is bonded to the first resin material by heat welding or hot pressing.
(4)

The multilayer structure according to (1) above,

in which the first resin material is bonded to the metallic material and the second resin material by simultaneous insert molding.
(5)

The multilayer structure according to any one of (1) to (4) above,

in which components of the second resin material are same as components of the first resin material.
(6)

An in-wheel motor including:

a wheel section that includes a multilayer structure including a metallic material, a thermoplastic first resin material bonded to the metallic material, and a thermoplastic second resin material that is bonded to the first resin material and contains carbon, the wheel section being rotated around a rotational axis;

a housing that is supported, in an inside space of the wheel section, by two support sections on the rotational axis and includes a heat radiating surface at an end portion on at least one side in a direction of the rotational axis; and

a stator core that is supported between the two support sections and inside the housing and has an inner circumferential surface of which a distance from the rotational axis is smaller than a distance from the rotational axis to an outer edge portion of the heat radiating surface.
(7)

The in-wheel motor according to (6) above,

in which the wheel section has a rim including a rim reinforcement section that is the multilayer structure.
(8)

The in-wheel motor according to (7) above,

in which the rim reinforcement section includes a cylindrical shape provided along an inner circumferential surface of the rim.
(9)

The in-wheel motor according to any one of (6) to (8) above,

in which the wheel section is provided such as to cover both ends of the rim in a direction of a rotational axis and has a side cover including a cover reinforcement section that is the multilayer structure.
(10)

The in-wheel motor according to (9) above,

in which the cover reinforcement section includes a rib shape formed on a surface on an inside of the side cover in the direction of the rotational axis.
(11)

The in-wheel motor according to any one of (6) to (10) above, including:

a heat transfer path of continuous solid members from the stator core to the heat radiating surface.
(12)

The in-wheel motor according to any one of (6) to (11) above,

in which the housing includes heat radiating surfaces at both end portions in the direction of the rotational axis.
(13)

The in-wheel motor according to any one of (6) to (12) above,

in which the stator core has an outer circumferential surface supported in face-face alignment with an inner circumferential surface of the housing.
(14)

The in-wheel motor according to any one of (6) to (13) above, including:

a driving substrate that is accommodated in the inside of the housing and controls an electromagnetic force generated by the stator core.
(15)

The in-wheel motor according to (14) above,

in which the driving substrate has a first substrate including an arithmetic processing section that executes a predetermined arithmetic program, and a second substrate provided further on the heat radiating surface side than the first substrate and including an electric power control section that performs control of electric power.
(16)

The in-wheel motor according to (15) above,

in which the driving substrate is provided adjacently to the heat radiating surface side relative to the second substrate and has a heat diffusing plate having at least a part thereof fixed in face-face alignment with the inside of the housing.
(17)

The in-wheel motor according to any one of (14) to (16) above,

in which the housing has an inner housing that accommodates the stator core, and a first outer housing that accommodates the driving substrate and includes the heat radiating surface.
(18)

The in-wheel motor according to (17) above,

in which the first outer housing is fixed in face-face alignment with an end face of the inner housing in the direction of the rotational axis.
(19)

The in-wheel motor according to (17) or (18) above, including:

a speed reduction gear that is provided on an opposite side of the stator core from the driving substrate and includes the heat radiating surface.
(20)

The in-wheel motor according to (19) above,

in which the speed reduction gear has
an output shaft that projects to the exterior of the inner housing and outputs rotation of a rotor rotated by magnetism of the stator core,
an inner gear fixed to the wheel section, and
a planetary gear meshing with the output shaft and the inner gear, and

the housing has a second outer housing provided on an opposite side of the inner housing from a first outer housing, supporting a rotary shaft of the planetary gear, and including the heat radiating surface.
(21)

The in-wheel motor according to (20) above,

in which the number of the planetary gears is two.
(22)

The in-wheel motor according to (20) or (21) above,

in which the second outer housing is provided in face-face alignment with at least a part of an end portion of the inner housing in the direction of the rotational axis.
(23)

The in-wheel motor according to any one of (6) to (22) above, including:

a sensor integrated circuit that is supported inside a rotor rotated by magnetism of the stator core and detects rotation of the rotor, and

a wall that shields the magnetism of the stator core and the rotor from the sensor integrated circuit.
(24)

An electric wheel including:

a housing including a heat radiating surface at an end portion on at least one side of a direction of a rotational axis;

two fixed shafts that are coaxial with the rotational axis and support the housing;

a stator core that is supported inside the housing and has an inner circumferential surface of which a distance from the rotational axis is smaller than a distance from the rotational axis to an outer edge of the heat radiating surface; and

a wheel section that includes a multilayer structure including a metallic material, a thermoplastic first resin material bonded to the metallic material, and a thermoplastic second resin material that is bonded to the first resin material and contains carbon, the wheel section being rotated around the rotational axis while accommodating the housing in an inside space thereof.
(25)

The electric wheel according to (24) above,

in which the heat radiating surface is fixed in face-face alignment with a support member holding the fixed shafts.
(26)

The electric wheel according to (24) or (25) above,

in which the wheel section is connected to an outer circumferential surface of the housing through a bearing, at an end portion in a direction of a rotational axis, and

the distance from the rotational axis to an outer edge of the heat radiating surface is equal to a distance from the rotational axis to an inner circumferential surface of the bearing.

### REFERENCE SIGNS LIST

1: Multilayer structure

2: Metallic material

3: First resin material

4: Second resin material

10: Electric wheel

12: Fixed shaft

14A, 14B: Support section

20: Wheel section

22: Rim

22M: Rim main body

22R: Rim reinforcement section

26: Side cover

26M: Cover main body

26R: Cover reinforcement section

30: Driving device

32: Housing

40: Inner housing

42: First inner housing

42A, 42B: End face

44: Second inner housing

44A: End face

44B: Projection

50: Outer housing

52: First outer housing

52A: Heat radiating surface

52B: End face

54: Second outer housing

54A: Projection

54B: Heat radiating surface

60: Motor section

62: Stator core

64: Rotor

66: Motor coil

68: Encoder substrate

68C: Sensor integrated circuit

70: First planetary gear mechanism

72: Rotor inner gear

72W: Wall section

74: Sun gear

76: Planetary gear

78: Rotational support member

78S: Output shaft

80: Driving substrate

82: First substrate

84: Second substrate

86: Heat diffusing plate

90: Speed reduction gear

92: Second planetary gear mechanism

94: Inner gear

96: Planetary gear

100: Support member

R: Rotational axis

1. A multilayer structure comprising:
a metallic material;
a thermoplastic first resin material bonded to the metallic material; and
a thermoplastic second resin material that is bonded to the first resin material and contains carbon,
the metallic material, the thermoplastic first resin material, and the thermoplastic second resin material being stacked on one another.

2. The multilayer structure according to claim 1,
wherein the first resin material is bonded to the metallic material by insert molding.

3. The multilayer structure according to claim 1,
wherein the second resin material is bonded to the first resin material by heat welding or hot pressing.

4. The multilayer structure according to claim 1,
wherein the first resin material is bonded to the metallic material and the second resin material by simultaneous insert molding.

5. The multilayer structure according to claim 1,
wherein components of the second resin material are same as components of the first resin material.

6. An in-wheel motor comprising:
a wheel section that includes a multilayer structure including a metallic material, a thermoplastic first resin material bonded to the metallic material, and a thermoplastic second resin material that is bonded to the first resin material and contains carbon, the metallic material, the thermoplastic first resin material, and the thermoplastic second resin material being stacked on one another, the wheel section being rotated around a rotational axis;
a housing that is supported, in an inside space of the wheel section, by two support sections on the rotational axis and includes a heat radiating surface at an end portion on at least one side in a direction of the rotational axis; and
a stator core that is supported between the two support sections and inside the housing and has an inner circumferential surface of which a distance from the rotational axis is smaller than a distance from the rotational axis to an outer edge of the heat radiating surface.

7. The in-wheel motor according to claim 6,
wherein the wheel section has a rim including a rim reinforcement section that is the multilayer structure.

8. The in-wheel motor according to claim 7,
wherein the rim reinforcement section includes a cylindrical shape provided along an inner circumferential surface of the rim.

9. The in-wheel motor according to claim 6,
wherein the wheel section is provided such as to cover both ends of the rim in a direction of a rotational axis and has a side cover including a cover reinforcement section that is the multilayer structure.

10. The in-wheel motor according to claim 9,
wherein the cover reinforcement section includes a rib shape formed on a surface on an inside of the side cover in the direction of the rotational axis.

11. An electric wheel comprising:
a housing including a heat radiating surface at an end portion on at least one side of a direction of a rotational axis;
two fixed shafts that are coaxial with the rotational axis and support the housing;
a stator core that is supported between the two fixed shafts and inside the housing and has an inner circumferential surface of which a distance from the rotational axis is smaller than a distance from the rotational axis to an outer edge of the heat radiating surface; and
a wheel section that includes a multilayer structure including a metallic material, a thermoplastic first resin material bonded to the metallic material, and a thermoplastic second resin material that is bonded to the first resin material and contains carbon, the metallic material, the thermoplastic first resin material, and the thermoplastic second resin material being stacked on one another, the wheel section being rotated around the rotational axis while accommodating the housing in an inside space thereof.
